(19) United States
(12) Patent Application Publication
(10) Pub. No.: US 2012/0120017 A1
(43) Pub. Date: May 17, 2012

(54) SYSTEM AND METHOD FOR DETERMINING OBJECT INFORMATION USING AN ESTIMATED DEFLECTION RESPONSE

(75) Inventors: Patrick Worfolk, Campbell, CA (US); Mihai M. Bulea, Santa Clara, CA (US)

(73) Assignee: SYNAPTICS INCORPORATED, Santa Clara, CA (US)

(21) Appl. No.: 12/948,455

(22) Filed: Nov. 17, 2010

(51) Int. Cl. G06F 3/045

(52) U.S. Cl. 345/174

(57) ABSTRACT

The embodiments described herein provide devices and methods that facilitate improved performance. Specifically, the devices and methods provide the ability to determine object information for objects causing deflection of a surface of a capacitive sensor device. The devices and methods are configured to determine an estimated deflection response associated with a deflection of the at least one sensing electrode using a set of sensor values, where the deflection was caused by one or more objects in contact with the input surface. The estimated deflection response at least partially accounts for effects of capacitive coupling with the object(s) in contact with the input surface, Object information may then be generated using the estimated deflection response. Where the input device is used to direct an electronic system the object information may be used to facilitate a variety of interface actions on a variety of different electronic systems.

### FIELD OF THE INVENTION

This invention generally relates to electronic devices.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

Some proximity sensor devices are detrimentally affected by physical deflection of parts of the sensor devices. For example, when a user touches or pushes on an input surface of a proximity sensor device, the input surface and the underlying sensing electrodes may be deflected to such an extent that the deflection degrades the performance of the device. For example, some proximity sensor devices may thus produce inaccurate measurements, estimates, or other information. Such degradation may be evident in touch screen devices and non-touch screen devices.

Some proximity sensor devices, or electronic systems in communications with proximity sensor devices, would also benefit from information about forces applied to the input surfaces of the sensor devices.

Thus, methods and devices for addressing the above are desirable. Other desirable features and characteristics will become apparent from the subsequent detailed description and the appended claims, taken in conjunction with the accompanying drawings and the foregoing technical field and background.

### BRIEF SUMMARY OF THE INVENTION

The embodiments of the present invention provide devices and methods that facilitate improved sensor devices. Specifically, the devices and methods provide the ability to determine object information for objects causing deflection of a surface of a capacitive sensor device. Example object information includes positional information and force estimates, such as for objects causing deflection. The devices and methods at least partially account for the effects of capacitive coupling with the objects causing the deflection in determining the object information.

In one embodiment, a capacitive input device comprises an input surface, at least one sensing electrode, and a processing system communicatively coupled to the at least one sensing electrode. The input surface is contactable by objects in a sensing region, and the at least one sensing electrode is configured to capacitively couple with objects in the sensing region. The processing system is configured to determine an estimated deflection response associated with a deflection of the at least one sensing electrode using a set of sensor values, where the deflection was caused by one or more objects in contact with the input surface. The estimated deflection response at least partially accounts for effects of capacitive coupling with the object(s) in contact with the input surface, The processing system is further configured to determine object information using the estimated deflection response. Where the input device is used to direct an electronic system. the object information may be used to facilitate a variety of interface actions on a variety of different electronic systems.

The estimated deflection response may be used to determine object information such as force or position estimates. The object information may be determined through iterative procedures, such as to produce refined, more accurate object information.

In one particular touch screen embodiment, the object information may be a position estimate that at least partially accounts for the effects of the deflection of the at least one electrode.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary system that includes an input device in accordance with an embodiment of the invention;

FIG. 2 is a top view of an input device in accordance with an embodiment of the invention;

FIGS. 3 and 4 are cross sectional side views of an input device in accordance with an embodiment of the invention;

FIGS. 5, 6 and 7 are projections of an exemplary total response, deflection response, and object response in accordance with an embodiment of the invention;

FIGS. 8, 9 and 10 are surface plots representing an exemplary total response, deflection response, and object response in accordance with an embodiment of the invention;

FIGS. 11-15 are graphical representations of sensor values in accordance with embodiments of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention provide input devices and methods that facilitate improved usability.

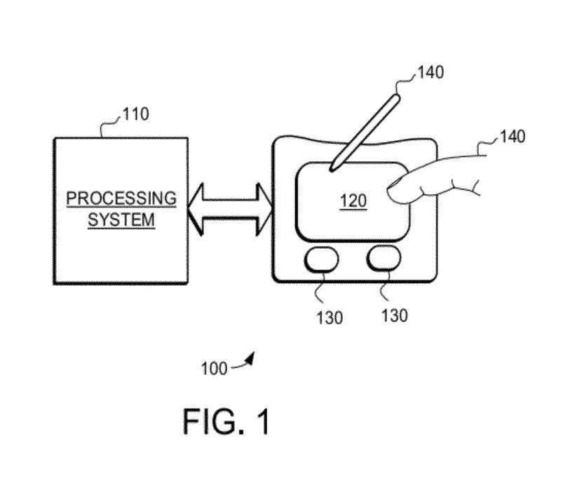

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and capacitive sensing technologies to detect user input in the sensing region 120. For example, the input device 100 comprises one or more sensing elements for capacitively detecting user input.

Some implementations are configured to provide images that span one, two, or three dimensions in space. Some implementations are configured to provide projections of input along particular axes or planes.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitting electrodes and one or more receiving electrodes. Transmitting sensor electrodes may be modulated relative to a reference voltage (e.g., system ground) to facilitate transmission, and receiving sensor electrodes may be held substantially constant relative to the reference voltage to facilitate receipt. Sensor electrodes may be dedicated transmitters or receivers, or may be configured to both transmit and receive.

In FIG. 1, a processing system (or “processor”) 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components; in some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In accordance with some embodiments, a position acquisition module is configured to acquire a set of sensor values using at least one sensing element of the input device. Likewise, a determiner module is configured to determine an estimated deflection response associated with a deflection of the at least one sensing element using the set of sensor values, the deflection caused by a force applied by an object to the input device, wherein the estimated deflection response at least partially accounts for effects of capacitive coupling with the object. The determiner module may also be configured to determine object information from the estimated deflection response.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes position in a plane. Exemplary “three-dimensional” positional information includes position in space and position and magnitude of a velocity in a plane. Further examples include other representations of spatial information. Historical data regarding one or more types of positional information may also be determined and/or stored, including, for example, historical data that tracks position, motion, or instantaneous velocity over time. Likewise, a “position estimate” as used herein is intended to broadly encompass any estimate of object location regardless of format. For example, some embodiments may represent a position estimates as two dimensional “images” of object location. Other embodiments may use centroids of object location.

“Force estimate” as used herein is intended to broadly encompass information about force(s) regardless of format. Force estimates may be in any appropriate form and of any appropriate level of complexity. For example, some embodiments determine an estimate of a single resulting force regardless of the number of forces that combine to produce the resultant force (e.g. forces applied by one or more objects apply forces to an input surface). Some embodiments determine an estimate for the force applied by each object, when multiple objects simultaneously apply forces to the surface. As another example, a force estimate may be of any number of bits of resolution. That is, the force estimate may be a single bit, indicating whether or not an applied force (or resultant force) is beyond a force threshold; or, the force estimate may be of multiple bits, and represent force to a finer resolution. As a further example, a force estimate may indicate relative or absolute force measurements. As yet further examples, some embodiments combine force estimates to provide a map or an “image” of the force applied by the object(s) to the input surface. Historical data of force estimates may also be determined and/or stored.

The positional information and force estimates are both types of object information that may be used to facilitate a full range of interface inputs, including use of the proximity sensor device as a pointing device for selection, cursor control, scrolling, and other functions.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

In one embodiment, an input device 100 comprises an input surface and at least one sensing electrode, with the sensing electrode communicatively coupled to the processing system 110. In this embodiment the input surface is contactable by objects in a sensing region, and the at least one sensing electrode is configured to capacitively couple with objects in the sensing region and to deflect in response to force applied to the input surface by objects in contact with the input surface. The processing system 110 is configured to determine an estimated deflection response associated with a deflection of the at least one sensing electrode using a set of sensor values, where the deflection was caused by an object in contact with the input surface. The determined estimated deflection response at least partially accounts for effects of capacitive coupling with the object in contact with the input surface, and the processing system is further configured to determine object information using the estimated deflection response. This object information may be used to facilitate a variety of interface actions on a variety of different electronic devices.

In one example, the processing system 110 may use the estimated deflection response to determine a force estimate (or multiple force estimates) for the object(s) causing the deflection. In another example, the processing system 110 may use the estimated deflection response to determine a position estimate (or multiple position estimates) for the object(s) causing the deflection. Such force and position estimates may be produced with or without iterations of other force or position estimates.

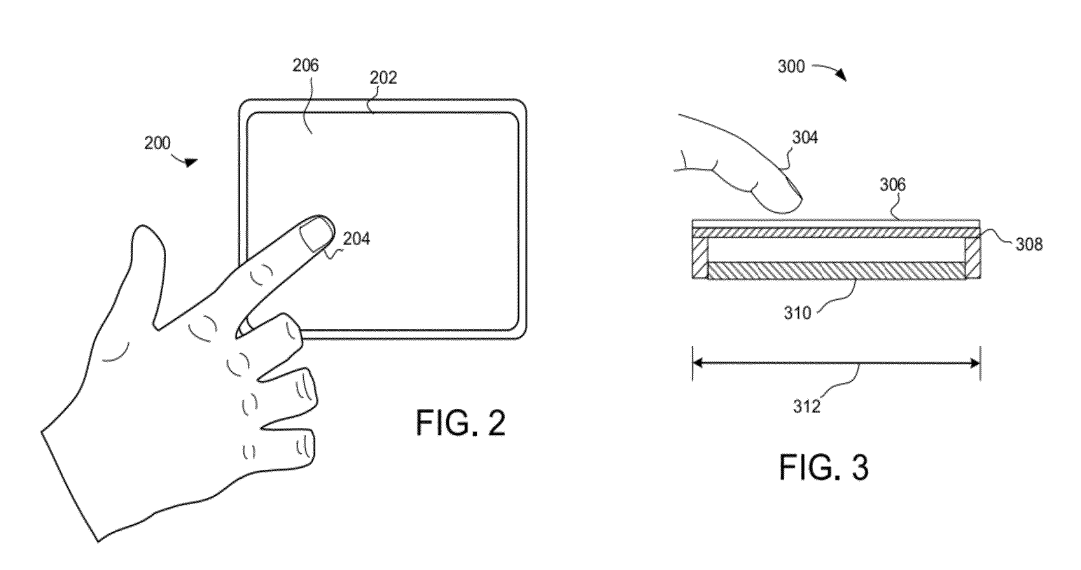

Turning now to FIG. 2, a top view of an exemplary input device 200 is illustrated. The input device 200 includes an input surface 206 and at least one sensing electrode (not shown). The input device 200 also includes a processing system (not shown) communicatively coupled to the at least one sensing electrode. The input device 200 is configured to capacitively sense objects (e.g., finger 204) in a sensing region 202 using the at least one sensing electrode. As was described above, the at least one sensing electrode can comprise any number of sensor electrodes of in any of a variety of arrangements. For example, the at least one sensing electrode can comprise a single sensor electrode, a set of sensor electrode aligned along one axis, arrays of electrodes aligned along orthogonal axes, and other configurations or spatial arrangements. Similarly, the at least one sensing electrode can be of any appropriate shape. For example, the at least one sensing electrode can reside in a single plane or be non-planer, and can have any number of curvy or linear portions, and of any appropriate size.

Where one or more objects in the sensing region 202 deflect the input surface 206, it also deflects the at least one sensing electrode. “Deflection” is used here to encompass all types of motion or change in configuration of the at least one sensing electrode in response to force applied to the input surface 206 by one or more input objects, and “deflect” is used here to refer to the action of deflection. For example, deflection includes substantially rigid motion, where a body translates or rotates without changing in shape. For example, rigid motion of an electrode may encompass rotation or translation of the electrode without a change in electrode characteristics such as size and curvature. As another example, deflection includes substantially non-rigid motion, where a body deforms or changes in shape. For example, non-rigid motion of an electrode includes stretching, compression, bending, and twisting. Deflection also includes combined rigid and non-rigid motion.

It should be noted that the type of deflection occurring in response to force by the input objects will depend largely upon the structure of the input device. For example, substantially rigid motion of input device components typically occur where those components are configured to be substantially more rigid relative to their mountings, supports, and other relevant aspects of their environment. As another example, non-rigid motion of input device components typically occur where those components are configured to be substantially less rigid relative to their mountings, supports, and other relevant aspects of their environment.

With input device 200, capacitive measurements obtained using the at least one sensing electrode includes both the effects of capacitive coupling to objects in the sensing region 202 and the effects of deflection of the at least one sensing electrode. The effects deflection can affect the accuracy of detecting objects in the sensing region, and can provide additional information about input provided by objects to the input device 200.

The term “deflection response” is used here to refer to the change in the capacitive coupling to the at least one sensing electrode that occur due to the deflection. That is, the deflection causes changes in arrangement and configuration of the at least one sensing electrode relative to other parts of the input device and the environment, such that the electric field surrounding the at least one sensing electrode is changed. This changes the capacitive coupling experienced by the at least one sensing electrode, and changes the sensor values that are produced using the at least one sensing electrode. Thus, the “deflection response” refers to an electrical response to the deflection.

The term “estimated deflection response” refers to the values determined by the input device (e.g. by the input device's processing system or some other processing element) that correspond to an estimate of the deflection response. The estimated deflection response may be in capacitance units, or some other units that reflect the changes in capacitance. Generally, the estimated deflection response is produced by accounting (in whole or in part) for the effects of capacitive coupling between the at least one sensing electrode and the at least one object causing the deflection.

Similarly, “object response” is used here to refer to the change in the capacitive coupling to the at least one sensing electrode that occur due to input object(s) being present and/or moving in the sensing region. Also, “estimated object response” refers to the values determined by the input device (e.g. by the input device's processing system or some other processing element) that correspond to an estimate of the object response.

The input device (e.g. through its processing system or other processing element) is configured to obtain a set of sensor values using the at least one sensing electrode, determine an estimated deflection response, and determine object information using the estimated deflection response. The estimated deflection response is associated with a deflection of the at least one sensing electrode using the set of sensor values. The deflection is caused by at least one object in contact with the input surface, and the estimated deflection response at least partially accounts for effects of capacitive coupling with the at least one object in contact with the input surface.

The sensor device may further comprise one or more conductors proximate to the at least one sensing electrode, wherein a capacitive coupling between the conductor(s) and the at least one sensing electrode changes with the deflection of the at least one sensing electrode. The conductor(s) may be of any shape or arrangement with respect to the at least one sensing electrode. For example, the conductor(s) may overlap, flank or surround, interleave, the at least one sensing electrode.

For example, the sensor device may further comprise a display screen underlying the at least one sensing electrode. The display screen may comprise one or more conductor(s) configured for use in displaying images on the display screen, where the capacitive coupling between the conductor(s) and the at least one sensing electrode changes with the deflection of the at least one sensing electrode.

The object information may comprise a position estimate, a force estimate, and/or some other estimate related to the object(s) in the sensing region or in contact with the input surface.

The processing system may be configured to determine the estimated deflection response in a variety of ways. Some examples are described in the following paragraphs.

The processing system may be configured to determine the estimated deflection response by determining a position estimate for the at least one object in contact with the input surface, determining a subset of the set of sensor values corresponding to locations away from the position estimate, and using the subset to determine the estimated deflection response. The subset may be a non-empty, proper subset of the set of sensor values, such that it includes at least one value, and not all of the values, of the set of sensor values.

The processing system may be configured to determine the estimated deflection response by fitting a parameterized function to the set or subset of the sensor values.

The processing system may be configured to determine the estimated deflection response by determining a position estimate for the at least one object in contact with the input surface, and by using the position estimate to at least partially account for capacitive coupling effects associated with the at least one object in contact with the input surface.

The processing system may be configured to determine the object information in a variety of ways. Some examples are described in the following paragraphs.

The processing system may configured to determine the object information by determining a position estimate using the estimated deflection response, determining a second estimated deflection response using the position estimate, and determining the object information using the second estimated deflection response. The second estimated deflection response is associated with the deflection of the at least one sensing electrode, and is a refinement over the first estimated deflection response.

The processing system may be further configured to determine a first position estimate for the at least one object in contact with the input surface. And the processing system may be configured to determine the estimated deflection response by using the set of sensor values and the first position estimate. And the processing system may be configured to determine the object information by determining a second position estimate for the at least one object in contact with the input surface using the estimated deflection response, where the second position estimate is a refinement over the first position estimate.

A variety of other techniques for determining estimated deflection responses and object information exist, and other examples are described below, in connection with other figures.

The processing system may be comprised of appropriate modules to perform the functions ascribed to it. For example, the processing system may comprise a position acquisition module and a determiner module. The position acquisition module may be configured to acquire a set of sensor values using at least one sensing electrode of the input device. The determiner module may be configured to determine an estimated deflection response and to determine object information using the estimated deflection response.

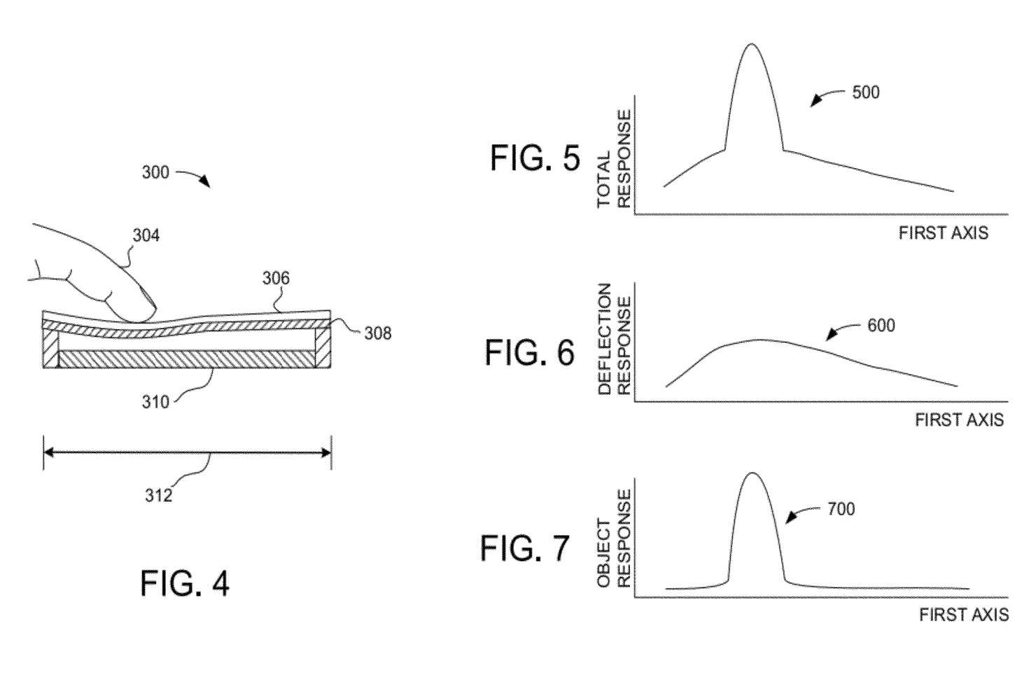

FIGS. 3-4 show an implementation of the example of FIG. 2. Specifically, FIGS. 3-4 show cross-sectional side views of an example input device 300 that has an input surface 306, at least one sensing electrode 308, and a conductor 310. A first axis 312 is also shown for orientation purposes. Also presented in FIGS. 3-4 is an input object 304 (a finger is shown) proximate to the input device 300. The input device 300 is configured such that force applied by the input object 304 to the input surface 306 causes the at least one sensing electrode 308 to deflect relative to the conductor 310. The conductor 310 is proximate to the at least one sensing electrode 308, such that capacitive coupling between the conductor 310 and the at least one sensing electrode 308 changes in a measurable way with the deflection of the at least one sensing electrode 308 relative to the conductor 310.

That is, deflection of the at least one sensing electrode 208 changes the relative distances between portions of the at least one sensing electrode 308 and portions of the conductor 310, and changes the electric field around them. Where the at least one sensing electrode 308 is electrically modulated with respect to the conductor 310, this changes the capacitances measured by the at least one sensing electrode 308.

The conductor 310 can comprise portions of the input device 300 that are dedicated to changing the electric field around the at least one sensing electrode in response to deflection of the at least one sensing electrode, or have other functions. For example, the conductor 310 may also electrically shield the input device 300 from external noise sources or electrically shield external components from noise produced by the operation of the at least one sensor electrode 308.

As another example, in some embodiments, the input device 300 comprises a display screen underlying the at least one sensing electrode 308, and the conductor is also used for display functions. For example, the conductor 310 may be a display electrode used for display operation. The display electrode may be driven to one or more voltages during display operation, such as the one or more V_{com} electrodes of liquid crystal display screens (LCDs) that are driven to a constant V_{com} voltage or to multiple voltages during display operation.

The input device 300 may or may not include additional conductors that also change in capacitively coupling with the at least one sensing electrode 308 in response to deflection of the at least one sensing electrode 308. These additional conductors may also underlie the at least one sensing electrode 308, or be in some other arrangement with respect to the at least one sensing electrode 208.

Turning now to FIG. 4, the input device 300 is illustrated with the input object 304 applying force to the input surface 306, such that the at least one sensing electrode 308 deflects. In this illustrated example, the at least one sensing electrode 308 is deflecting toward the conductor 310. As described above, this deflection of the at least one sensing electrode 308 changes the capacitance measured by the at least one sensing electrode 308.

The processing system (not shown) of the input device 300 is configured to determine an estimated deflection response associated with a deflection of the at least one sensing electrode 308 using a set of sensor values that includes the effects of the deflection. The deflection may be caused by input object 304 contacting the input surface 306. The processing system determines this estimated deflection response by at least partially accounting for the effects that capacitive coupling with the input object 304 (and other input objects as appropriate) has on the set of sensor values. The estimated deflection response can be used to determine a variety of object information 204.

FIGS. 5-7 illustrate an exemplary total response, deflection response, and object response for the input device 300. The examples of FIGS. 5-7 may be the response along a cross-section of a sensor (such as what may be associated with a row or column of pixels in an imaging sensor), a projection of responses (such as what may be associated with a profile sensor), or some other appropriate one-dimensional representation. Turning now to FIG. 5, an example of a total response 500 associated with the at least one sensing electrode 308 is illustrated in graphical form. Specifically, FIG. 5 shows an exemplary total response 500 for the deflection scenario illustrated in FIG. 4.

The total response 500 includes at least two distinct effects. A first portion of the total response is an object response that reflects changes due to the proximity and/or location of the input object 304 relative to the at least one sensing electrode 208. A second portion is a deflection response that reflects changes due to the deflection of the at least one sensing electrode 308. In many embodiments, and to first order, the object response and deflection responses are additive effects, and thus the total response can be considered to be the superposition of the object response and the deflection response. Thus, an object or a deflection response can be subtracted or otherwise removed from a total response without substantially affecting the other response—at least to first order.

In general, the changes associated with the object response are concentrated in the portions of the at least one sensing electrode 308 near the input object 304, since the changes to the electric field caused by the presence and motion of the input object 304 are relatively localized. Meanwhile, the changes associated with the deflection response tend to cover a larger portion. However, that is not the case in some embodiments.

Turning now to FIGS. 6 and 7, these figures illustrate an exemplary deflection response 600 and an exemplary object response 700 for the deflection scenario shown in FIG. 4. As may be seen in FIGS. 5, 6 and 7, the total response 500 is effectively the superposition of the deflection response 600 and the object response 700.

In some embodiments of the invention, an input device (such as input device 200 or 300) is configured to obtain a set of sensor values using at least one sensing electrode. The set of sensor values may be reflective of a total response (such as total response 500) that includes a deflection response (such as deflection response 600) and an object response (such as object response 700). The set of sensor values are likely quantized, and formed of a discrete set of values that indicate measurements made using the at least one sensing electrode.

The input device is further configured to determine an estimated deflection response associated with a deflection of the at least one sensing electrode using the set of sensor values. That is, the input device develops an estimate of the actual deflection response using the sensor values obtained. The estimated deflection response may be in any appropriate form, including as discrete values, coefficients of functions, functions, and the like. The estimated deflection response at least partially accounts for the effects of capacitive coupling with the input object(s). That is, the estimated deflection response accounts for the object response to at least a partial extent. The input device is also configured to determine object information using the estimated deflection response.

In some embodiments, the sensor values and estimated deflection responses are made along one dimension, such as along the first axis of FIGS. 3-4. This may be the case in embodiments designed to provide projections of input along particular axes or planes (e.g. “profile” sensors). For example, profile sensors may generate sets of sensor values for defined coordinate systems, such as “X” and “Y” coordinates if using Cartesian coordinate systems.

Estimated deflection responses may also be made along one dimension in embodiments designed to provide images of two or higher dimensions, where particular one-dimensional sections or slices of the image are used in determining estimated deflection responses and object information. For example, one or multiple one-dimensional slices may be taken that intersect a peak (or multiple peaks) in the image, As another example, one or multiple one-dimensional slices may be taken, where each pass through a same estimated position of an input object (or through different estimated positions of multiple input objects).

In embodiments configured to provide images of two, three, or more dimensions, the sensor values and the estimated deflection response may be made along two dimensions (taking two-dimensional sections as appropriate). This approach can also be analogized to three and higher dimensions.

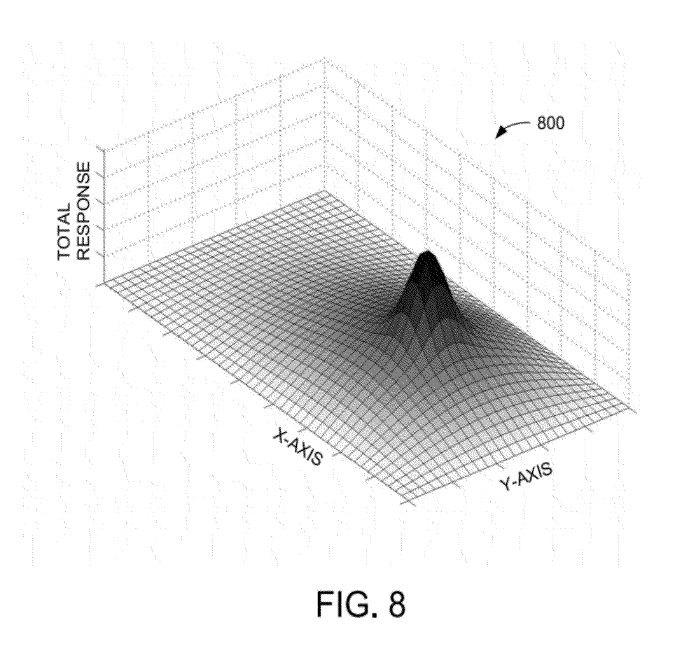

FIGS. 8-10 illustrate the total response, the object response, and the deflection response as a surface plots spanning first and second axes and corresponding to the sensing region. The first and second axes may be X and Y axes. FIGS. 8-10 illustrate these responses as two dimensional “images” of capacitive effects in the sensing region.

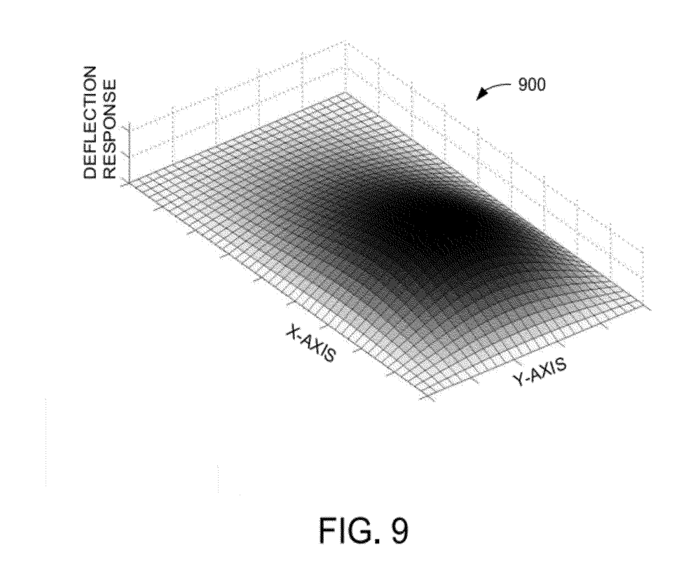

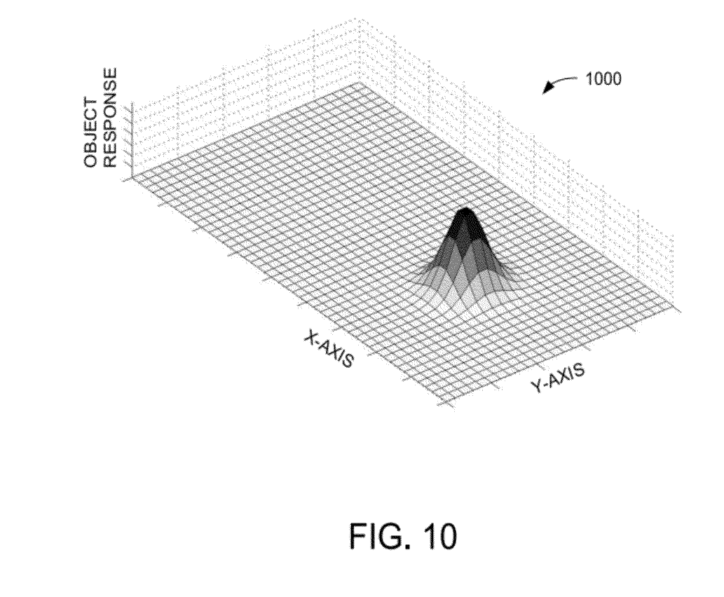

Turning now to FIG. 8, an exemplary two dimensional total response 800 for the example of FIGS. 3-4 is illustrated as a surface plot. Like the example of FIG. 5, total response 800 includes both deflection and object responses. And also like the previous examples, the estimated deflection response can be determined by accounting at least in part for the object response. Turning now to FIGS. 9 and 10, these figures illustrate an exemplary deflection response 900 and an exemplary object response 1000 for the exemplary total response 800 shown in FIG. 8. These responses have relationships with each other that are similar to those described in conjunction for FIGS. 5-7, except these are two dimensional instead of one dimensional.

In accordance with the embodiments of the invention, a variety of different techniques may be used to determine the estimated deflection response. Some techniques are based on an assumption that the physical deflection (and the associated electrostatic changes) would be similar to a particular shape. Some techniques use filters or thresholds to remove or reduce the object response effects from the sensor values. Some techniques include fitting curves to part or all of the sensor values. Some techniques use estimated position(s) of the object(s) (in contact with the input device or in the sensing region of the input device) to effectuate accounting for the capacitive effects of the object(s). Other techniques may not use position estimates to determine the estimated deflection response.

Various embodiments may use these techniques in isolation, or in combination. For example, some embodiments may use position estimates with curve fits to produce estimated deflection responses. As another example, some embodiments may use thresholds and filters both to produce estimated deflection responses. Other examples use any combination and number of assumptions of deflection shapes, filters, thresholds, curve fits, and other techniques.

A variety of these techniques will now be discussed in greater detail.

Some techniques are based on an assumption that the physical deflection (and the associated electrostatic changes) would be similar to a particular shape. For example, in some embodiments, it may be assumed that the deflection responses may be approximated by modeling the physical deflection with lower-order bending modes. These embodiments may determine estimated deflection responses by identifying which sensor values and/or what amount of some or all of the set of sensor values correspond to lower-order bending modes. For example, applying appropriate spatial filters can remove all or part of higher special frequency components. As another example, a function such as a sinusoid, polynomial, or other linear or non-linear function that may or may not come from a specific physical model may be fit to the sensor values.

As a further example, some embodiments use filters to determine estimated deflection responses. As above, filters may be used to identify parts associated with bending modes. However, filters may also be used to reduce or remove sharper changes in sensor values, without regard to the mode of the deflection. For example, in some embodiments, it may be assumed that the object response produces sharper changes in the sensor values than the deflection response, such that filtering out such sharper changes produces an adequate estimated deflection response for determining object information.

As yet another example, some embodiments use thresholds to determine estimated deflection responses. The thresholds may be set at manufacture, at start-up, during operation when particular input conditions are met, dynamically based on input conditions, etc. With thresholds, sensor values past or between particular thresholds may be removed or weighted differently from other sensor values. For example, in some embodiments, sensor values above a threshold value may be assumed to be largely due to object response and is removed. As another example, in some embodiments, sensor values above a threshold may be reduced according to an appropriate weighting function. As yet another example, sensor values below a threshold may be removed.

Some techniques fit one-dimensional curves or two-dimensional, surfaces to some or all of the sensor values. The sensor values may or may not be pre-processed before the fitting (e.g. to reduce noise, highlight changes from baseline sensor values, etc.) One example of a curve fit (that of fitting a function to the sensor values) has already been discussed. Some other examples are discussed below.

Some embodiments determine the estimated deflection response by assuming that a particular function adequately describes the general shape of the deflection response, and determine parameters to fit this function to a whole set or a partial set of sensor values. This function may be a parameterized function that is derived in any number of ways, including by assuming that lower-order bending modes are adequate models of the deflection that sensing electrodes would experience, finding appropriate fits to empirical data taken of sensing electrodes bending, deriving models using a physics-based model of the physical bending of sensing electrodes, and the like. The parameterized function may also be a convenient function assumed to model the deflection response. For example, a parameterized function may comprise one or more terms of discrete expansions of sinusoids, such as sine or cosine functions.

Some embodiments determine a set of values to be fit, and fit parameterized functions to those values by determining parameters that reduce the deviation between the function and values to be fit. For example, some embodiments fit a combination of sinusoidal functions such as f(x)=A·cos(Bx+C) to part of a set of sensor values corresponding to locations away from input object positions. The fitting produces parameters that may comprise the deflection response or be used to determine the deflection response. The deflection response may be used to provide a force estimate. For example, the amplitude of a sinusoid may be directly correlated with a force estimate in some embodiments.

The parameterized function may also be based on models descriptive of the actual physical deflection of the at least one electrode and its effects on capacitive coupling. As one specific example, thin-plate bending and parallel plate capacitance models may be used to produce the parameterized functions.

In various embodiments, adjustments (e.g. different weights) may be made for values that correspond to different portions of the sensing region. For example, sensor values determined to be largely determined by the deflection response may have greater weight, and sensor values determined to be largely determined by the object response (or noise) may have lesser weight. The weight may be unrelated, linearly related, or non-linearly related to an estimated contribution of the deflection response to the sensor values.

Some techniques use a determination of the position(s) of object(s) in the sensing region, such as the position of one or more objects causing the deflection to determine the estimated deflection response. The determination of the positions(s), referred to as a position estimate, is used in these techniques to account for at least some of the effects of capacitive coupling with the object(s) found in the set of sensor values. Furthermore, in some embodiments, other types of information may also be used with the position estimate to determine the estimated deflection response.

The position estimate may be determined using any suitable position determination technique and procedure. In some embodiments, objects entering, moving in, and exiting the sensing region change the electric field near the at least one electrode, such that the input device may capacitively detect objects through changes in the sensor values obtained using the at least one sensing electrode. The resulting changes in the sensor values may be used by itself, with one or more prior readings or baselines, and/or other information (such as prior force, deflection and position estimates) to determine the position(s) of object(s) in the sensing region, including object(s) in contact with the input device. Any appropriate data analysis method may be used to determine the position estimates from these sensor values, including detecting peaks, calculating centroids, etc.

Some embodiments use the position estimate to at least partially account for capacitive coupling effects with the object(s) in contact with the surface and causing deflection. For example, some embodiments use the position estimate to determine which subset of the sensor values are less affected by the capacitive coupling effects of the object(s), or which subset of the sensor values are more indicative of deflection effects. Some embodiments determine a subset of sensor values that correspond to locations away from the position estimate (that is, from position(s) indicated by the position estimate). The subset is non-empty, such that it contains at least one of the sensor values of the set; the subset is also proper, such that it does not contain all of the sensor values of the set. These embodiments use this subset to determine the estimated deflection response. This approach focuses on the sensor values associated with portions of the sensing region away from where objects are estimated to be (thus portions of the sensing region which are not estimated to contain objects). Generally, sensor values associated with portions away from the objects are primarily indicative of the capacitive effects associated with deflection.

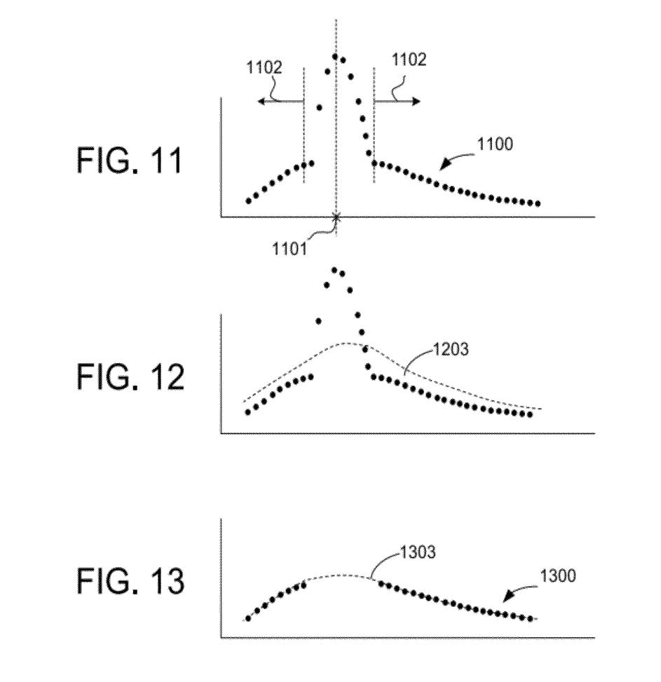

Turning now to FIG. 11, an exemplary set of sensor values 1100 corresponding to those that may be obtained by the input device for the total response of FIG. 5 is illustrated. The set of sensor values reflect a measure of both the capacitive effects of deflection (the deflection response) and the capacitive effects of coupling with the object (the object response). From the sensor values shown in FIG. 11, a position estimate may be made for an object that corresponds to location 1101. This position estimate can be used to determine a subset of sensor values that correspond to locations away from the position estimate. For example, the subset of values in regions 1102.

In the example of FIG. 11, the regions 1102 correspond to sensor values largely determined to be representing the deflection response. The subset of sensor values in regions 1102 correspond to locations away from the position estimate, and as such are largely unaffected by the object response and thus form a good estimated deflection response that accounts for much of the object response. However, in other embodiments, the subset of sensor values thus obtained may form estimated deflection responses that are not as good at accounting for the object response, but are still useable as estimated deflection responses.

As discussed above, some embodiments use fitting techniques to determine the estimated deflection response. The fit may be to the entire set of sensor values, including values that are largely determined by object response and not deflection response. This is shown in FIG. 12, where the estimated deflection response is derived from a curve fit 1203 of all of the sensor values 1100.

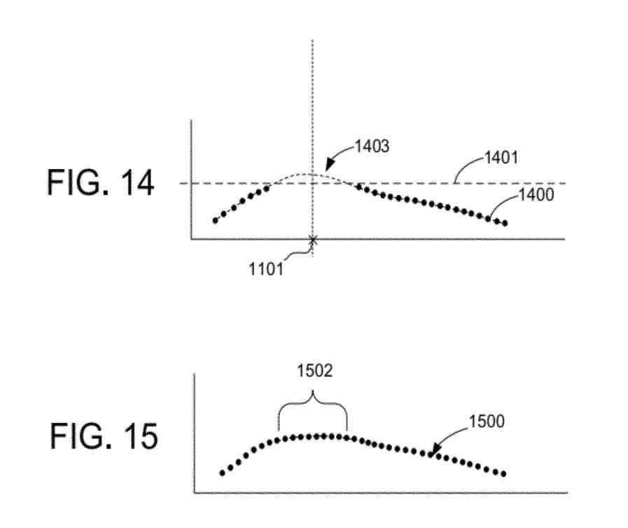

The fitting techniques may also be applied to a partial set of sensor values. Any appropriate data analysis methods (e.g. thresholding, estimating positions, etc.) may be used to produce a subset of the sensor values to which a fit is made. Turning to FIG. 13, the sensor values 1300 are the subset of the sensor values 1100 that correspond to locations away from the position estimate 1101. The estimated deflection response is derived from a curve fit 1303 of this subset of sensor values 1300. Turning to FIG. 14, the sensor values 1400 are the subset of the sensor values 1100 that are below a threshold 1401. The estimated deflection response is derived from a curve fit 1403 of this subset of sensor values 1400.

Turning to FIG. 15, this graph shows how sensor values that are removed may be use to produce an estimated deflection response that includes virtual sensor values. Any appropriate estimation method (straight line interpolation, etc.) may be used. For example, these virtual sensor values 1502 may be estimated using the sensor values in regions 1102. And, the estimated deflection response may be derived from the combination of the sensor values that are not removed 1500 and the virtual sensor values 1502.

These examples all account for the effects of capacitive coupling with the object(s) partially. Particular techniques may even substantially or entirely account for the effects of capacitive coupling with the object(s).

The estimated deflection responses may be used to determine object information, including force estimates, position estimates, etc.

The deflection response reflects the actual physical deflection of the at least one sensing electrode. As such, the estimated deflection response may be used to determine estimates about the force(s) causing the physical deflection.

A variety of techniques may be used to determine this force estimate from the estimated deflection response. For example, data correlating known force applications with deflection responses may be gathered, and a mapping between the two empirically determined. As another example, physical models correlating force applications to physical deflections, and physical deflection to capacitive effects, may be used to determine how deflection responses correspond to applied forces. Depending on the technique, the part of the estimated deflection response used to determine force may include the maximum, minimum, mean, etc., the area or volume under a 2D profile or 3D image of the estimated deflection response, the first derivative of a 2D profile or 3D image of the estimated deflection response, etc.

The mapping may be stored as thresholds, look-up tables, functions, etc. for determining force estimates using the estimated deflection response, as appropriate for the application.

The estimated deflection response may also be used to provide a position estimate or to refine a position estimate. For example, the shape of the estimated deflection response may be used in making an estimate of the position(s) of object(s) in contact with the input surface. In some embodiments, the deflection response has local peaks (or maxima) where objects are in contact with and deflecting the input surface. As another example, the estimated deflection response can be used to provide a more accurate estimated object response, and the estimated object response used to determine position estimate(s). For example, some embodiments use the deflection response to determine how an earlier position estimate should be adjusted. As another example, some embodiments remove the estimated deflection response from the set of sensor values to generate an object response. The object response can then be used with an appropriate position determination technique to produce position estimate(s) (and to estimate the number of input objects and thus the number of positions to estimate, as applicable.) as appropriate.

Some embodiments iterate the determination of estimated deflection responses, estimated object responses, and/or position estimates. For example, in some embodiments, a first position estimate is made from the sensor values, without regard for the deflection response; then, the first position estimate is used in determining a first estimated deflection response. Then, the first estimated deflection response is used to determine a second position estimate that is a refinement over the first position estimate. Various embodiments may not iterate any estimates, while others iterate once, twice, or more times.

Using the estimated deflection response to refine a position estimate may be useful in embodiments where the deflection response affects detrimentally the position estimates that are made without taking the deflection response into account. That is, in these embodiments, the deflection response is a significant contributor to the sensor values, relative to the accuracy needed in the position estimates; in such systems, determining the position estimates from the sensor values without accounting for the deflection response in part or whole, results in an error in position estimate that causes erroneous outputs or responses. Also, in some embodiments, a first position estimate made without accounting for the deflection response may be accurate enough for some uses (e.g. in waking up the device, determining where to focus data analyses efforts, determining the estimated deflection response, etc.), but not for some uses (e.g. fine cursor positioning, pointing, etc.).

Furthermore, estimated object responses, estimated deflection responses, and object information (including force estimates and position estimates) may be iterated zero, one or multiple times in an iterative fashion, with each iteration producing a more refined estimate. Various embodiments that perform such iterative determinations may performed a set number of iterations, until the estimate converges (e.g. the previous estimate and the current estimate is within a defined range), or both (e.g. until the estimate converges, but no more than N number of iterations).

In a first specific example of embodiments that do not iterate estimations, some embodiments determine an estimated deflection response from the sensor values, without using a position estimate in the determination. The embodiments may use the estimated deflection response to determine force and/or position estimates.

In a first specific example of embodiments that do iterate estimations, the process is similar to what is described in the paragraph above, except that a position estimate is determined, and that position estimate is used to produce a second estimated deflection response and a second force/and or position estimate, where the second estimate is a refinement over the first estimate.

In a second specific example of embodiments that do not iterate estimations, some embodiments determine an estimated deflection response from the sensor values, without using a position estimate in the determination. The embodiments may then use the estimated deflection response in combination with the sensor values to produce a position estimate (e.g. such as in accounting for the deflection response in the sensor values, to produce an estimated object response); or, the embodiments may then use the estimated deflection response to determine a force estimate; or the embodiments may do both.

In a second specific example of embodiments that do iterate estimations, the process is similar to what is described in the paragraph above, except that a position estimate is determined, and that position estimate is used to produce a second estimated deflection response and a second force and/or position estimate, where the second estimate is a refinement over the first estimate.

In a third specific example of embodiments that do iterate estimations, the embodiments determine a first position estimate and a first estimated deflection response from the sensor values. The estimated deflection response is then used with the first position estimate or the sensor values to determine a second position estimate. The second position estimate is then used with the sensor values or the first estimated deflection response to produce a second estimated deflection response. The second estimated deflection response is then used with the second position estimate or the sensor values to produce a third position estimate. Force estimates, if any, may be made from the first estimated deflection response, the second estimated deflection response, or both.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A capacitive sensor device comprising:
an input surface contactable by objects in a sensing region;
at least one sensing electrode configured to capacitively couple with objects in the sensing region; and
a processing system communicatively coupled to the at least one sensing electrode, the processing system configured to:
obtain a set of sensor values using the at least one sensing electrode;
determine an estimated deflection response associated with a deflection of the at least one sensing electrode using the set of sensor values, the deflection caused by at least one object in contact with the input surface, wherein the estimated deflection response at least partially accounts for effects of capacitive coupling with the at least one object in contact with the input surface; and
determine object information using the estimated deflection response, the object information being related to the at least one object in contact with the input surface.

2. The capacitive sensor device of claim 1, wherein the processing system is configured to determine the object information using the estimated deflection response by:
determining a position estimate using the estimated deflection response;
determining a second estimated deflection response associated with the deflection of the at least one sensing electrode using the position estimate, the second estimated deflection response being a refinement over the estimated deflection response.
determining the object information using the second estimated deflection response.

3. The capacitive sensor device of claim 1 wherein the processing system is configured to determine the object information using the estimated deflection response by:
determining a position estimate for the at least one object in contact with the input surface using the estimated deflection response.

4. The capacitive sensor device of claim 1 wherein the processing system is configured to determine the object information using the estimated deflection response by:
determining a force estimate for the at least one object in contact with the input surface using the estimated deflection response.

5. The capacitive sensor device of claim 1 wherein the processing system is further configured to:
determine a first position estimate for the at least one object in contact with the input surface,
wherein the processing system is configured to determine the estimated deflection response using the set of sensor values by:
using the set of sensor values and the first position estimate, and
wherein the processing system is configured to determine the object information using the estimated deflection response by:
determining a second position estimate for the at least one object in contact with the input surface using the estimated deflection response, the second position estimate being a refinement over the first position estimate.

6. The capacitive sensor device of claim 1 wherein the processing system is configured to determine the estimated deflection response by:
determining a position estimate for the at least one object in contact with the input surface; and
using the position estimate to at least partially account for capacitive coupling effects associated with the at least one object in contact with the input surface.

7. The capacitive sensor device of claim 1 wherein the processing system is configured to determine the estimated deflection response by:
determining a position estimate for the at least one object in contact with the input surface;
determining a subset of the set of sensor values corresponding to locations away from the position estimate, wherein the subset is a non-empty, proper subset of the set of sensor values; and
using the subset to determine the estimated deflection response.

8. The capacitive sensor device of claim 1 wherein the processing system is configured to determine the estimated deflection response by:
using parts of the set of sensor values corresponding to lower-order modes.

9. The capacitive sensor device of claim 1 wherein the processing system is configured to determine the estimated deflection response by:
fitting a parameterized function.

10. The capacitive sensor device of claim 1, further comprising:
a conductor proximate to the at least one sensing electrode, wherein a capacitive coupling between the conductor and the at least one sensing electrode changes with the deflection of the at least one sensing electrode.

11. The capacitive sensor device of claim 1, further comprising:
a display screen underlying the at least one sensing electrode, wherein the display screen comprises a conductor configured for use in displaying images on the display screen, and wherein a capacitive coupling between the conductor and the at least one sensing electrode changes with the deflection of the at least one sensing electrode.

12. A touch-screen device comprising:
a touch surface contactable by input objects in a sensing region;
an array of sensing electrodes proximate to the touch surface, the array of sensing electrodes configured to capacitively couple with input objects in the sensing region;
a display screen underlying the array of sensing electrodes, wherein the display screen comprises a conductor configured for use in displaying images on the display screen; and
a processing system communicatively coupled to the array of sensing electrodes, the processing system configured to:
obtain a first set of sensor values using the array of sensing electrodes;
determine a position estimate for a deflection of the array of sensor electrodes using the first set of sensor values, wherein the deflection is caused by force applied to the touch surface by at least one input object, and wherein the deflection causes a change in a capacitive coupling between the array of sensing electrodes and the conductor;
determine an estimated deflection response for the deflection of the array of sensor electrodes using the position estimate and the first set of sensor values; and
determine an estimate selected from a group consisting of a revised position estimate and a force estimate, using the estimated deflection response.

13. A method for responding to user input provided to a sensor device having at least one sensing electrode, wherein conductive material in the at least one sensing electrode is configured to capacitively couple to objects near the sensing electrode and to deflect in response to a force applied by objects to the sensor device, the method comprising:
obtaining a set of sensor values using the conductive material;
determining an estimated deflection response associated with a deflection of the at least one sensing electrode using the set of sensor values, the deflection caused by a force applied by at least one object to the sensor device, wherein the estimated deflection response at least partially accounts for effects of capacitive coupling with the object;
determining object information about the at least one object using the estimated deflection response; and
generating an output from the object information.

14. The method of claim 13, wherein the determining the object information about the at least one object using the estimated deflection response comprises:
determining a position estimate using the estimated deflection response;
determining a second estimated deflection response associated with the deflection of the at least one sensing electrode using the position estimate, the second estimated deflection response being a refinement over the estimated deflection response.
determining the object information using the second estimated deflection response.

15. The method of claim 13, wherein the determining the object information about the at least one object using the estimated deflection response comprises:
determining a position estimate for the at least one object using the estimated deflection response.

16. The method of claim 13, wherein the determining the object information about the object using the estimated deflection response comprises:
determining a force estimate for the at least one object using the estimated deflection response.

17. The method of claim 13, further comprising:
determining a first position estimate for the at least one object;
wherein the determining the estimated deflection response associated with the deflection of the at least one sensing electrode comprises:
using the set of sensor values and the first position estimate, and
wherein the determining the object information about the at least one object using the estimated deflection response comprises:
determining a second position estimate for the at least one object using the estimated deflection response, the second position estimate being a refinement over the first position estimate.

18. The method of claim 13, wherein the determining the estimated deflection response associated with the deflection of the at least one sensing electrode comprises:
determining a position estimate for the at least one object; and
using the position estimate to at least partially identify capacitive coupling effects associated with the at least one object.

19. A processing system for a capacitive input device, the processing system comprising:
a position acquisition module configured to acquire a set of sensor values using at least one sensing electrode of the input device, the at least one sensing electrode configured to capacitive couple with objects near the at least one sensing electrode; and
a determiner module configured to:
determine an estimated deflection response associated with a deflection of the at least one sensing electrode using the set of sensor values, the deflection caused by a force applied by at least one object to the input device, wherein the estimated deflection response at least partially accounts for effects of capacitive coupling with the at least one object; and
determine object information about the at least one object using the estimated deflection response.

20. The processing system of claim 19, wherein the determiner module is configured to determine the estimated deflection response associated with the deflection of the at least one sensing electrode using the set of sensor values by:
using parts of the set of sensor values corresponding to lower-order modes.

21. The processing system of claim 19, wherein the determiner module is configured to determine the estimated deflection response associated with the deflection of the at least one sensing electrode using the set of sensor values by:
fitting a parameterized function.
